(19) United States
(12) Patent Application Publication
(10) Pub. No.: US 2022/0405044 A1
(43) Pub. Date: Dec. 22, 2022

(54) Emergency Vehicle Audio Synchronization

(71) Applicant: Federal Signal Corporation, Oak Brook, IL (US)

(72) Inventors: Christopher Radzik, New Lenox, IL (US); Joseph L. Van Luyk, Bourbonnais, IL (US); Vincent S. Fleszewski, Crown Point, IN (US); Russell K. Mars, Frankfort, IL (US)

(21) Appl. No.: 17/807,250

(22) Filed: Jun. 16, 2022

Related U.S. Application Data
(60) Provisional application No. 63/202,643, filed on Jun. 18, 2021.

(51) Int. Cl. G06F 3/16; H04W 56/00; H04W 4/90

(52) U.S. Cl. CPC G06F 3/165; H04W 56/0025; H04W 4/90

(57) ABSTRACT

An example system for a synchronizing audio on emergency vehicles can include a receiver configured to accept a synchronization signal. The example system can also include a processor configured to use the synchronization signal to determine a correct playback time for a message to remain in sync with other emergency vehicles.

### BACKGROUND

Vehicular emergency warning systems often include a high-power amplifier and loudspeaker system which is primarily used for asking for the right of way by use of a distinct and recognizable tone. These systems can include numerous audio inputs, such as radio and microphone level audio, that can be output on the high-power amplifier and loudspeaker. A secondary purpose of these systems is to broadcast voice over the loudspeaker to provide information and/or instruction to persons nearby.

Each vehicle's audio is normally free-running and not synchronized. This can sometimes be desirable while siren tones are playing to easily recognize the presence of more than one vehicle. For other audible features, such as voice, this can cause additional confusion to the scene, and potentially effect intelligibility.

### SUMMARY

An example system for a synchronizing audio on emergency vehicles can include: a receiver configured to accept a synchronization signal; and a processor configured to use the synchronization signal to determine a correct playback time for a message to remain in sync with other emergency vehicles.

### DESCRIPTION OF THE FIGURES

FIG. 1 shows an example system for synchronizing playback of messages by emergency vehicles.

FIG. 2 shows another view of the example system of FIG. 1.

FIG. 3 shows another view of the example system of FIG. 1.

FIG. 4 shows another view of the example system of FIG. 1.

FIG. 5 shows another example system for synchronizing playback of messages by emergency vehicles and warning systems.

### DETAILED DESCRIPTION

A system and method for synchronizing audio across multiple emergency vehicle's loudspeakers is proposed in the following disclosure.

Presently, when multiple vehicles are playing audio from their emergency warning systems, each vehicle's audio runs asynchronously. By synchronizing the audio from multiple emergency vehicles, pedestrians and other motorists hear the same audio no matter where they are in relation to a group of emergency vehicles.

More specifically, by synchronizing the audio from various vehicular sources, clear and uniform audio can be broadcast from a group of two or more vehicles. These vehicles can also be setup to form a public address system that can be accessed by an on-scene commander to further improve safety for first responders and other motorists/pedestrians.

Examples of emergency vehicles include, without limitation, police cars, fire trucks, ambulances, etc. Emergency vehicle loudspeakers typically are designed for maximum sound output at frequency ranges used in warning tones, such as wail and yelp. Because of this, they typically have a poor frequency response at lower audio frequencies.

As vehicle soundproofing has improved, warning tone penetration into other motorists' vehicles has decreased. To combat this, emergency warning systems suppliers have designed separate auxiliary low frequency amplifier and speakers to generate low frequency versions of warning tones to complement the standard high-power amplifier and loudspeaker.

The proposed system can include emergency vehicles having both high and low frequency amplifier and speakers. This speaker arrangement covers a wider range of frequencies used in voice, and therefore improves intelligibility.

The system 100 can be configured to have certain audio synchronize (e.g., voice), but other audio (e.g., tones) remain asynchronous. Alternatively, the audio can sync/un-sync based on conditional programming on the vehicle's state. For example, while the vehicle is moving, audio is asynchronous, and, while parked, the audio is synchronized. This allows pedestrians and motorist to audibly identify more than one moving emergency vehicle based on hearing two asynchronous tones. When the emergency vehicle switches to a blocking/warning mode, it can synchronize to any other vehicles that are already on scene.

In some examples, the synchronized audio can be a pre-recorded and/or pre-set message that is selected from a plurality of messages. In other examples, the audio can be a custom message that is pre-recorded or recorded at a scene as needed. The audio can also be other pre-set and/or custom tones or other audible signals.

One method for synchronizing audio uses a radio receiver to establish an accurate common time base from vehicle to vehicle. For any cyclical audio, such as a repeating tone or pre-recorded voice message, the system can use this common time base to determine exactly where to start the audio to remain synchronized with another vehicle. Some examples of this radio receiver include, but are not limited to, GPS, Bluetooth, cellular, and Wi-Fi.

In addition to emergency vehicles, it may be desirable for messages and siren tones to be synchronized across an entire community. In-order-to accomplish this, the emergency vehicle could synchronize with outdoor warning systems and/or indoor warning systems that are present within the community. The same methodology that is used to synchronize emergency vehicles could be utilized to synchronize both siren tones and messages with the outdoor warning systems and/or indoor warning systems.

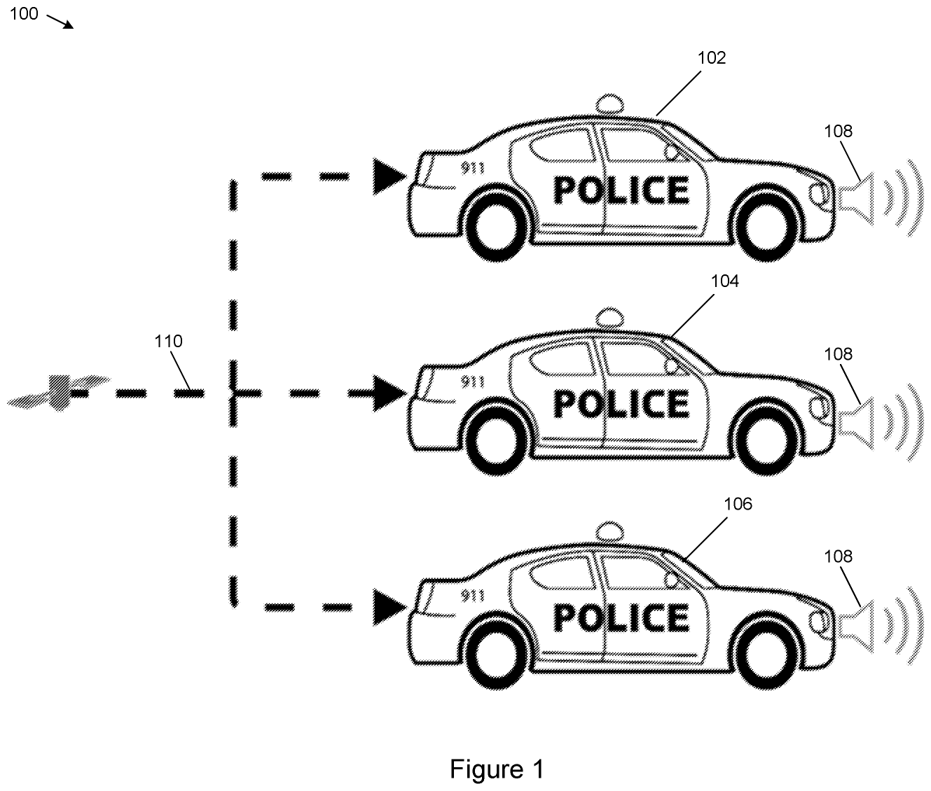

FIG. 1 shows an example system 100 having a group of emergency vehicles 102, 104, 106 using GPS receivers to receive a GPS signal 110 to synchronize audio. This method relies on each vehicle 102, 104, 106 playing the same audio on a speaker 108, initiated by the operator of the vehicle.

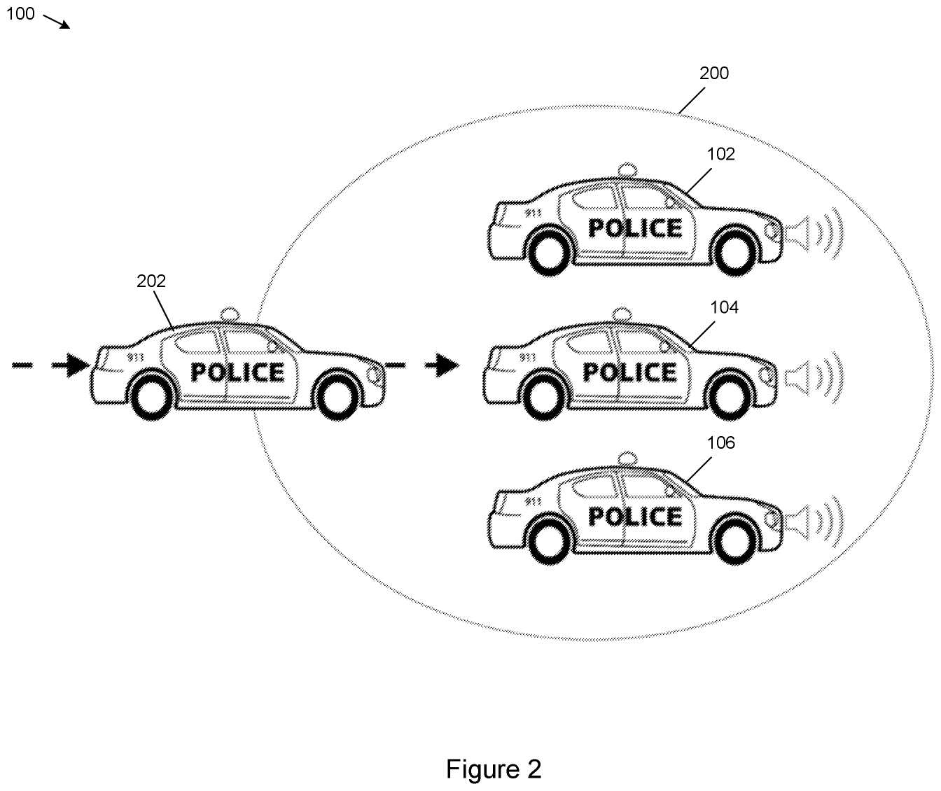

For some audio, such as voice messages, starting in the middle of a repeating voice message may be undesirable. The system 100 may include provision for detecting other vehicles that are nearby. Vehicle detection can be determined with cameras, microphones, radios and/or other sensors. An example of a vehicle 202 entering a zone 200 and detecting the other vehicles 102, 104, 106 is shown in FIG. 2. In example embodiments, the zone 200 can define a specified amount of space, such as 10 feet, 25 feet, 50 feet, 100 feet, 200 feet, 500 feet, 0.5 miles, etc.

In this case, if the operator of the vehicle 202 attempts to play audio that is the same as the other vehicles 102, 104, 106 within its range, it can synchronize its audio with the vehicle(s) 102, 104, 106 which is already playing audio. If no vehicles are nearby and playing audio, it can start its audio from the beginning. The first vehicle to start playing the audio becomes the one that all subsequent vehicles will synchronize to.

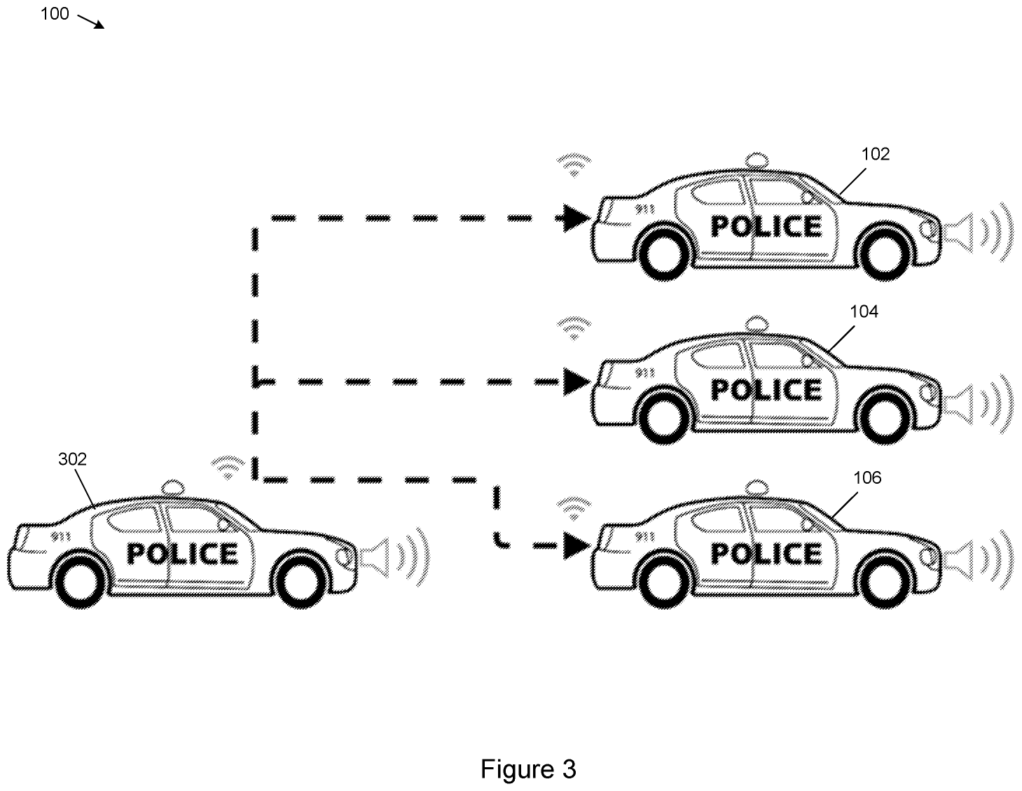

Another method for synchronizing audio is to allow a vehicle 302 to send its audio stream to any nearby vehicles 102, 104, 106 and use their amplifier/loudspeakers. This method can use proximity detection described in the previous method along with two-way wireless communication to stream audio. An example of this would be an on-scene commander in the vehicle 302 broadcasting a public-address voice message, which is repeated on the speakers of the vehicles 102, 104, 106. FIG. 3 shows an example of this method.

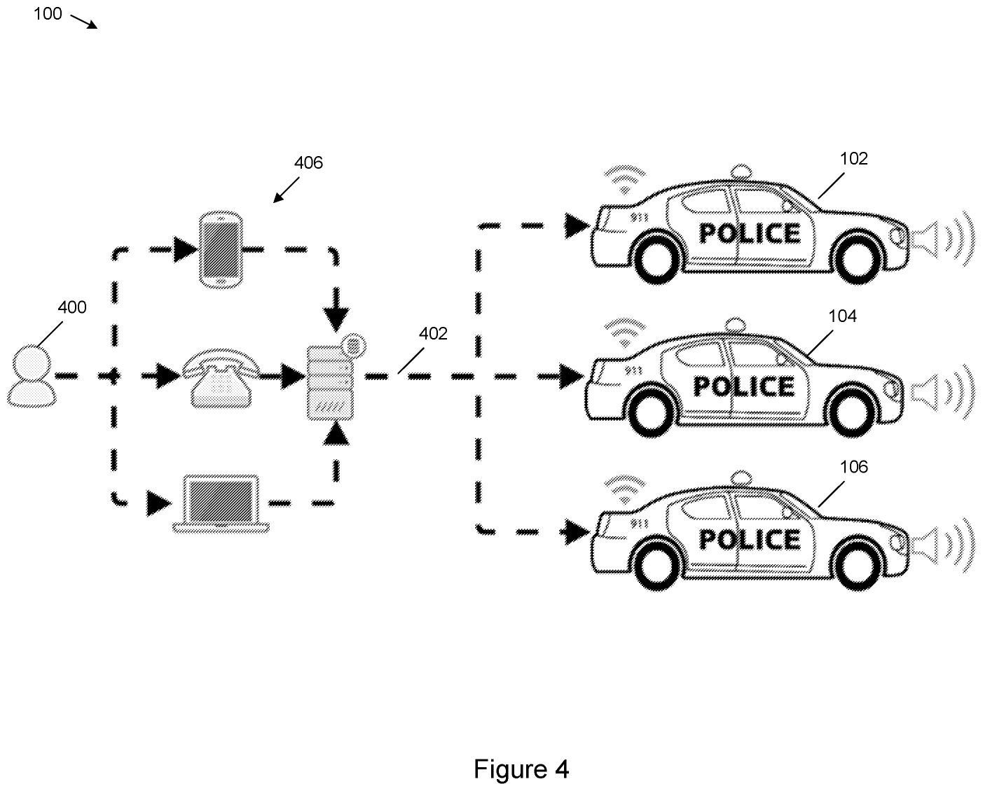

Yet another method would allow a remote user 400 to send audio to a group of emergency vehicles 102, 104, 106 over a long-distance wireless network 402 (e.g., cellular) using a graphical user interface on a device 406 such as a tablet, cellphone, or computer. If the device 406 running the graphical user interface contains a microphone, the remote user 400 can directly stream audio from their voice to the emergency vehicles 102, 104, 106. They could also record and maintain a local library of audio files. These files can be pushed to all the emergency vehicles 102, 104, 106 to allow the vehicle operator to control the audio. FIG. 4 shows an example of this type of audio synchronization.

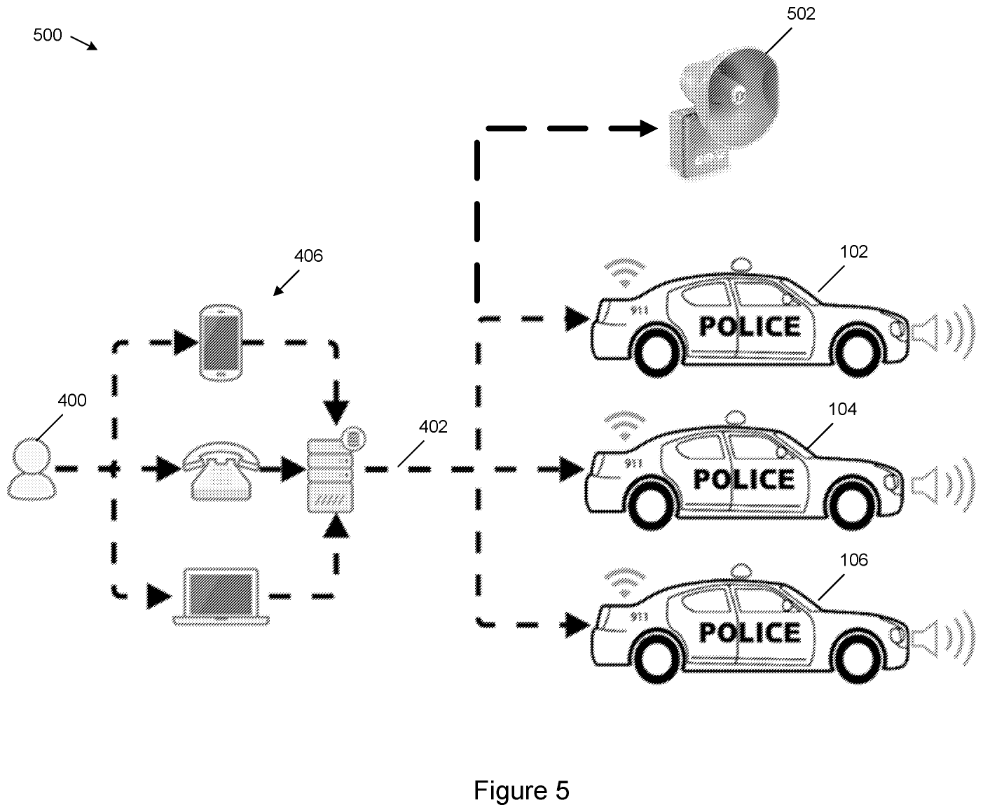

Referring now to FIG. 5, another example system 500 is shown. In the system 500, addition to synchronizing audio with the emergency vehicles 102, 104, 106, the audio is synchronized with an outdoor warning speaker 502. In this example, the outdoor warning speaker 502 can be part of an outdoor warning system. One non-limiting example of such a speaker is the SelecTone® Amplified Speaker from Federal Signal Corporation. One non-limiting example of such a warning system is the Commander® siren control system from Federal Signal Corporation. Many configurations are possible.

The same methodology that is used to synchronize emergency vehicles could be utilized to synchronize both siren tones and messages with the outdoor warning speaker 502 as part of an outdoor warning system and/or an indoor warning system.

In some cases, it may be desirable for the siren tone or message to be initiated by the emergency vehicle, the outdoor warning system (or the indoor warning system), and/or the device 406. As a result, the equipment in all three installation locations would have the ability to initiate the siren tone or message or receive instructions to synchronize with the initiated siren tone or message.

In the examples provided herein, the system includes one or more computing devices that allow for the creation, transfer, synchronization, and/or playback of the messages. In these examples, the computing devices each include a processor and memory. The memory encodes instructions which, when executed by the processor, allows the processor to provide the functionality described herein.

The memory includes a random access memory (“RAM”) and a read-only memory (“ROM”). The computing devices can further include a mass storage device. The mass storage device is able to store software instructions and data. One or more of these memories can be used to store, transmit, synchronize, and playback the messages described herein.

The mass storage device and its associated computer-readable data storage media provide non-volatile, non-transitory storage for the computing devices. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central processing unit can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing devices.

According to various embodiments, the system may operate in a networked environment using logical connections to remote network devices through a network, such as a wireless network, the Internet, or another type of network. The computing device may also include an input/output controller for receiving and processing input from a number of other devices, including a touch user interface display screen, or another type of input device. Similarly, the input/output controller may provide output to a touch user interface display screen or other type of output device.

As mentioned, the mass storage device and the RAM of the computing device can store software instructions and data. The software instructions include an operating system suitable for controlling the operation of the computing devices. The mass storage device and/or the RAM also store software instructions, that when executed by the CPU, cause the computing devices to provide the functionality discussed in this document.

What is claimed is:

1. A system for a synchronizing audio on emergency vehicles, comprising:
a receiver configured to accept a synchronization signal; and
a processor configured to use the synchronization signal to determine a correct playback time for a message to remain in sync with other emergency vehicles.

2. The system of claim 1, further comprising high and low frequency speakers and amplifiers that cover a wide range of audible frequencies, with the high and low frequency speakers being configured to playback the message.

3. The system of claim 2, further comprising a radio receiver capable of receiving an audio signal with the message from a nearby emergency vehicle and playing the message over the high and low frequency speakers.

4. The system of claim 3, further comprising a graphical user interface that allows new audio messages to be transferred to the system.

5. The system of claim 1, further comprising a remote computing device, wherein the remote computing device has a microphone that allows for recording of the message and transfer of the message directly to a plurality of the other emergency vehicles.

6. The system of claim 1, wherein the message is a series of tones or prerecorded.

7. The system of claim 1, further comprising an outdoor warning speaker, wherein the message is synchronized with the outdoor warning speaker.

8. The system of claim 1, wherein the processor defines a common time base as part of the synchronization signal.

9. The system of claim 1, wherein the processor defines a zone for the emergency vehicles, and wherein another emergency vehicle entering the zone will receive the synchronization signal and playback the message.

10. The system of claim 9, wherein a first vehicle of the emergency vehicles to playback the message becomes a synchronizer, and wherein other of the emergency vehicles synchronize playback of the message with the first vehicle.

11. A method for a synchronizing audio on emergency vehicles, comprising:
accepting a synchronization signal; and
using the synchronization signal to determine a correct playback time for a message to remain in sync with other emergency vehicles.

12. The method of claim 11, further comprising high and low frequency speakers and amplifiers that cover a wide range of audible frequencies, with the high and low frequency speakers being configured to playback the message.

13. The method of claim 12, further comprising receiving an audio signal with the message from a nearby emergency vehicle and playing the message over the high and low frequency speakers.

14. The method of claim 13, further comprising a graphical user interface that allows new audio messages to be transferred.

15. The method of claim 11, further comprising a remote computing device, wherein the remote computing device has a microphone that allows for recording of the message and transfer of the message directly to a plurality of the other emergency vehicles.

16. The method of claim 11, wherein the message is a series of tones.

17. The method of claim 11, wherein the message is prerecorded or custom.

18. The method of claim 11, further comprising defining a common time base as part of the synchronization signal.

19. The method of claim 11, further comprising:
defining a zone for the emergency vehicles; and
when another emergency vehicle enters the zone, receiving the synchronization signal for playback of the message.

20. The method of claim 19, wherein a first vehicle of the emergency vehicles to playback the message becomes a synchronizer, and wherein other of the emergency vehicles synchronize playback of the message with the first vehicle.
